(19) United States
(12) Patent Application Publication
(10) Pub. No.: US 2010/0061564 A1
(43) Pub. Date: Mar. 11, 2010

(54) AMBIENT NOISE REDUCTION SYSTEM

(76) Inventors: Richard Clemow, Bucks (GB); Alastair Sibbald, Edinburgh (GB); Robert David Alcock, Northampton (GB)

Correspondence Address: DICKSTEIN SHAPIRO LLP, 1825 EYE STREET NW, Washington, DC, 20006-5403, US

(21) Appl. No.: 12/525,889

(22) PCT Filed: Feb. 6, 2008
(86) PCT No.: PCT/GB2008/000403

§ 371 Date: Nov. 16, 2009

(30) Foreign Application Priority Data
Feb. 7, 2007 (GB) 0702295.7

(51) Int. Cl. G10K 11/16

(52) U.S. Cl. 381/71.6; 381/71.11

(57) ABSTRACT

An adaptive, feed-forward, ambient noise-reduction system includes a reference microphone for generating first electrical signals representing incoming ambient noise, and a connection path including a circuit for inverting these signals and applying them to a loudspeaker directed into the ear of a user. The system also includes an error microphone for generating second electrical signals representative of sound (including that generated by the loudspeaker in response to the inverted first electrical signals) approaching the user's ear. An adaptive electronic filter is provided in the connection path, together with a controller for automatically adjusting one or more characteristics of the filter in response to the first and second electrical signals. The system is configured to constrain the operation of the adaptive filter such that it always conforms to one of a predetermined family of filter responses, thereby restricting the filter to operation within a predetermined and limited set of amplitude and phase characteristics.

The present invention relates to an ambient noise reduction system of the adaptive feed-forward type; the system being intended primarily for use with earphones or headphones, but being equally applicable to other devices in which an electroacoustic transducer (“speaker”) is held close to the ear, such as a telephone handset. These devices will be referred to generically hereinafter as “Ear-proximal Speaker-carrying Devices”, or briefly “ESDs”.

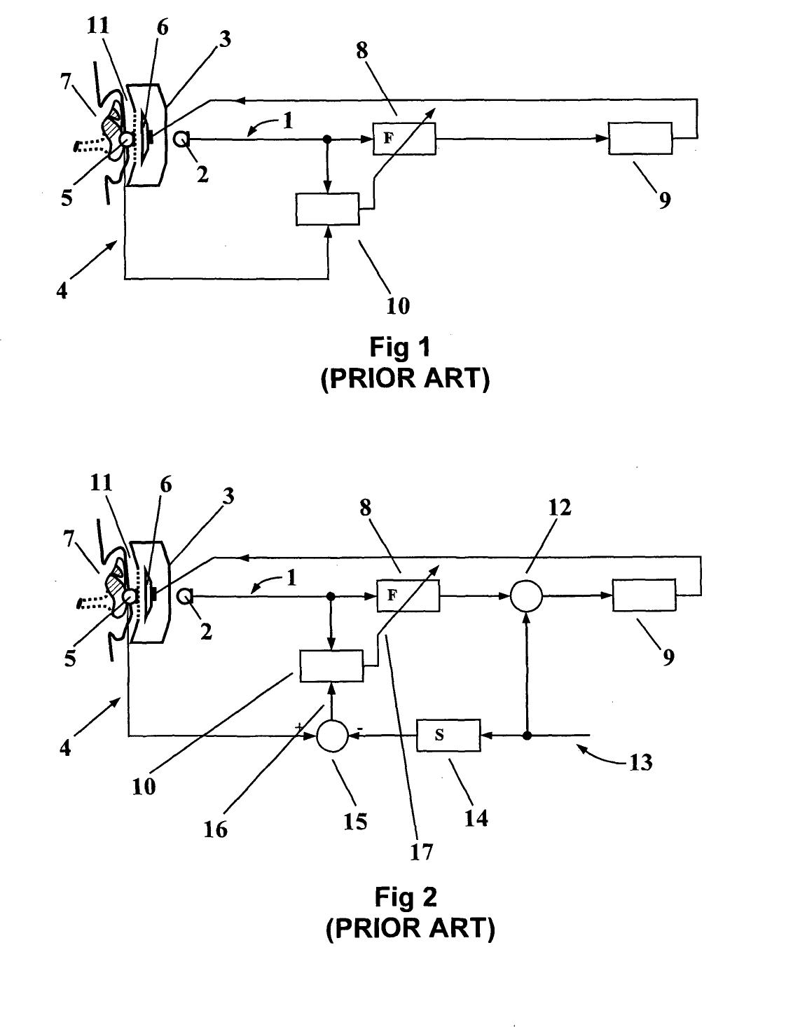

FIG. 1 shows the principles of a prior art adaptive feed-forward noise reduction system, as described for example by Chaplin et al in U.S. Pat. No. 4,122,303. In principle, the characteristics of a feed-forward filter are modified, or controlled, in response to an error signal derived from an error microphone, in order to adapt the system to provide optimal noise reduction according to some predetermined metric.

A reference microphone signal 1, representative of the ambient noise in the vicinity of an ESD such as an earphone 3, is generated by a reference microphone 2 positioned to receive ambient noise approaching the earphone 3. Moreover, an error microphone signal 4, representative of the ambient noise in the vicinity of the entrance to the listener's ear 7, is generated by an error microphone 5 positioned between the ESD's speaker 6 and the ear 7, to detect the sound actually entering the ear. The reference microphone signal 1 is passed through an adaptive electronic filter 8 to an amplifier 9, which drives the speaker 6. Additionally, the reference microphone signal 1 is fed into the reference input of an adaptive controller 10, and the error microphone signal 4 is fed into the error input of the adaptive controller 10, which outputs filter coefficients F which control the characteristics of the adaptive filter 8.

It will be appreciated that the adaptive filter 8 may also include an adjustable time delay element in series therewith.

The system is designed so that the speaker 6 creates an acoustic signal which, in principle, is equal in magnitude, but opposite in polarity, to ambient noise reaching the ear via an acoustic leak 11 or other paths. Consequently, destructive wave interference occurs between the incoming acoustic noise and its inverse, generated via the speaker 6, such that the ambient acoustic noise level perceived by the listener is reduced, and ideally completely cancelled.

Hereinafter, certain important parameters of the system are identified as follows:

S represents the transfer function from the output of the adaptive filter 8 to the error microphone signal 4;

F represents the transfer function of the adaptive filter 8; and

N represents the ratio of the transfer function of the ambient noise to the error microphone signal 4 divided by the transfer function from the ambient noise to the reference microphone signal 1.

Accordingly, S includes the speaker response, amplifier response, acoustic effects of the zone between the speaker and ear, and the response of the error microphone, whereas N represents the transfer function from the ambient to the ear and includes the acoustic effects of the zone between the speaker and ear and any differences between the error and reference microphone characteristics.

It is easy to see that ideal performance is achieved when

F·S=N

and hence the ideal filter F is given by

$$F = \frac{N}{S}$$

FIG. 2 shows a prior art example of this type of system, including means to mix in a desired audio signal 13, such as a music or speech signal, for example. The overall operation of the system shown in FIG. 2 is similar to the system of FIG. 1. However, a summer 12 is inserted between the adaptive filter 8 and the amplifier 9, and is used to mix in the desired audio signal 13. Further, a subtractor 15 receives the error microphone signal 4 on its positive input and the adaptive controller 10 receives the output of the subtractor 15, instead of receiving the error microphone signal 4 directly as shown in FIG. 1. The desired audio signal 13 is filtered by a compensation filter 14, the output of which is applied to the negative input of the subtractor 15.

The system is designed so that the compensation filter 14 ideally has a transfer function S′ which is identical to S, so that the modified desired audio signal which reaches the negative input of subtractor 15 via the path through the compensation filter 14 exactly balances the modified desired audio signal which reaches the positive input of subtractor 15 via summer 12, amplifier 9, speaker 6 and error microphone 5, with the intention that the desired audio signal does not significantly influence the adaptive filtering (otherwise the desired signal could be cancelled, or at least distorted, by the adaptive filtering action). Such compensation arrangements are in common use in prior art noise reducing headphones. The adaptive controller 10 generates the filter F coefficients 17 to control the adaptive filter 8.

Such adaptive feed-forward systems solve some of the problems which occur in non-adaptive (fixed) feed-forward systems, but introduce problems of their own and, in order to understand the present invention, it is necessary to first review some of the problems associated with non-adaptive systems.

It order to obtain good performance from a feed-forward system, a key requirement is the ability to implement an electronic filter F, having specific amplitude and phase responses (and hence time delay), such that the acoustic reduction signal is as close as possible to that required for perfect acoustic cancellation. The filter F depends on S, as shown above. This requirement presents a practical problem for manufacturers of mass-produced products, as the microphones and speakers used in the noise reduction system will have, within any manufacturing batch, a spread of gains, usually known as tolerance, which may be ±3 dB or higher. Thus the required electronic filter gain will vary considerably between units. The accepted solution to this problem is to provide a gain adjustment, in the form of a trimmer potentiometer, which is manually adjusted on the production line, adding to cost.

Another factor that affects the required electronic filter gain, and in some cases also the required electronic filter amplitude and phase response, is the acoustic leakage 11 through and/or around the edge of the ESD, which device may take any of a variety of forms, as described earlier. Thus the acoustic leakage can also take several forms, including leakage through the seals of flexible in-ear “canal-phones”, leakage around the edge of loose-fitting “ear-bud” style earphones, leakage through the padded cushions of “supra-aural” headphones that rest against the outer ear, or leakage around the edges of a telephone handset held to the ear. For each of these form factors, moreover, the way in which the ESD physically fits to the ear varies between people due to head and ear shape, thus materially changing the amount of acoustic leakage. Even for one individual, the fit of an ESD can be different each time it is worn or used, resulting in leakage changes.

In human terms, the shape of the outer ear (pinna), which is different for each person, influences the way the padded cushions of a supra-aural headphone seal against the ear, influencing the ambient noise ingress. Furthermore, the seal will generally improve (the acoustic leakage will decrease) if the headband exerts more pressure. Headband pressure will generally change in dependence on the user's head size, thus the acoustic leakage will in general depend on the user's head size as well as ear shape. Yet another variation is caused by a known “bedding down” effect of padded cushions, whereby foam or other materials used for padding deteriorate with time and use, or start to mould themselves to the shape of the pinna, thus altering the effectiveness of the seal and hence the amount of acoustic leakage.

For in-ear earphone types using seals made of flexible materials, the effectiveness of the seal changes in dependence upon how far the earphone is pushed into the ear, which may be different each time it is inserted. For loose fitting in-ear earphones, commonly called “ear-buds”, the amount of acoustic leakage will vary depending on the exact positioning within the ear.

A further example scenario is a speaker which is held to the ear, for example a hand-held telephone. In this case, the user holds the telephone against the ear, forming a partial seal. The seal is however extremely variable, depending on how hard it is pressed against the ear and how it is positioned. In U.S. Pat. No. 7,031,460, it is postulated that, in practice, the user will position the telephone handset to maximise the signal-to-noise ratio, thus optimising noise reduction performance. However, this expedient is only effective within certain bounds, and one of the objects of the present invention is to provide superior performance for this form factor by using an adaptive filter.

Two further practical problems, unrelated to the variable acoustic leakage, occur in feed-forward systems. The first relates to the achievement of acceptable amounts of noise reduction across as wide a frequency bandwidth as possible. The use of a single reference microphone restricts the usable upper frequency limit in some physical arrangements, notably the telephone handset and the supra-aural headphone type. A solution using multiple microphones is described in UK patent application No. GB 0601536.6 and can be applied to the present invention in place of the single reference microphone. The second problem relates to the requirement that the adaptive electronic filter must not introduce a significant time delay, requiring very fast processing in a digital implementation. A solution to this problem is described in UK patent application No. GB 0607338.1.

Some prior art systems also attempt to adjust the filtering applied to the desired audio input signal, or include compensation for the acoustic path from the speaker to the reference microphone. Systems in accordance with the present invention require neither of these features, although they can be included, if desired, without departing from the scope of the invention.

It is clear from the foregoing that a major problem in any feed-forward system is that unpredictable acoustic leakage variation will occur for virtually all physical arrangements.

As regards adaptive feed-forward noise reduction systems, most of the prior art is based on the use of a least mean squares (LMS) control algorithm to update the coefficients of a finite impulse response (FIR) filter. Such prior art is exemplified by U.S. Pat. No. 5,018,202 to Takahashi et al, which describes the need for an adaptive filter which “ . . . is able to provide arbitrary amplitude and phase characteristics . . . ”. Some of the prior art further describes stability issues that occur in these systems and a commonly-felt need to “detune” the control algorithm in order to maintain stability, at the expense of compromised noise reduction performance. In this respect, U.S. Pat. No. 6,741,707 to Ray et al proposes a method of maintaining stability without compromising noise reduction performance using a modified LMS algorithm. Moreover, U.S. Pat. No. 5,745,580 to Southward, et al proposes a way of reducing the computational burden by first designing a long filter (for example by the LMS method) and then shortening the filter before using it in the feed-forward path.

Notably, all of these prior art systems seek to allow the adaptive filter to adapt over the full range of possible filter shapes, even though such adaptive freedom leads to compromised performance in many practical circumstances.

Prior art adaptive systems have a number of other disadvantages, including the following:
If the ambient noise signal falls to such a low level that the system has no signal on which the adaptive controller can operate, or where the ambient noise is at such a low level that electronic system noise or inherent microphone noise masks the ambient noise signal, it is not possible for the system to adapt. Means are thus provided to detect this condition and inhibit the operation of the adaptive controller. Clearly, if the acoustic leakage changes under these circumstances, the system will not adapt.
If a desired audio signal is present, the error microphone will detect the desired signal generated by the speaker and the adaptive filter will attempt to cancel out the desired signal. To avoid this, some of the prior art subtracts a filtered version of the desired audio signal from the error microphone signal to minimise the interference with the adaptive controller. However, in practice, this compensation is significantly less than perfect, due to speaker distortion components and other factors, and some method of inhibiting the operation of the adaptive controller is required.
In order to maintain stability, the performance is compromised. Stability becomes harder and harder to achieve as the system bandwidth is increased. Most practical systems are therefore limited to an upper frequency well below 1 kHz. One of the benefits of the feed-forward system is that it has the potential to achieve a much wider bandwidth than this, as described in the aforementioned UK patent application No. GB 0601536.6, thus stability is a serious limitation on performance.
The algorithms typically employ a digital FIR feed-forward filter, which must be restricted in length in order to avoid excessive computational requirements. However, restricting the filter length limits the ability of the filter to control the low frequency part of the spectrum, thereby in turn limiting the effectiveness of noise reduction. Infinite impulse response (IIR) filters are not generally used due to the difficulty of computing the coefficients and maintaining stability.
Sound conducted through the human body is picked up by the error microphone and can interfere with the operation of the adaptive controller. A particular example occurs when the user speaks. The acoustic voice signal is transmitted through the air, and it is picked up by both the error microphone and the reference microphone. The system cannot distinguish this voice signal from ambient noise and it is cancelled correctly. However, the error microphone also picks up a second signal derived from the voice, conducted through the body, primarily through bones in the head. This additional signal adds to that transmitted acoustically through the air, and the system will adapt to cancel the combined error microphone signal. This set of adaptive filter coefficients will however be incorrect for ambient noise, thus reducing the performance of the noise reduction system.

It is clear from the foregoing that the implementation of viable feed-forward systems and, in particular, adaptive feed-forward systems, presents major practical difficulties, and it is the object of this invention to provide an adaptive system in which at least one such difficulty is reduced or eliminated.

According to the invention from one aspect there is provided an adaptive feed-forward system for reducing ambient noise perceived by a listener to an ear-proximal speaker-carrying device (briefly “ESD”), the system comprising a reference microphone means for sensing ambient noise approaching the ESD and for providing first electrical signals representative of the noise sensed thereby; a connection path conveying said first electrical signals to the speaker of the ESD; means in said connection path for inverting said first electrical signals; an error microphone means for sensing sounds approaching the ear canal of the listener and for providing second electrical signals representative of the sounds sensed thereby, said sounds including noise generated by the speaker of the ESD in response to the inverted first electrical signals conveyed thereto over said connection path; adaptive electronic filter means in said connection path; and control means for adjusting one or more characteristics of said filter means in response to said first and second electrical signals; the system being characterised by means constraining said adaptive filter means to always conform to one of a predetermined family of filter responses, and thereby to operate within a predetermined and limited set of amplitude and phase characteristics.

By this means, the present invention provides a system for adapting the electronic filter means of a feed-forward ambient noise-reduction system, the adjustments being constrained so that the filter response always falls within a desirable family of filter responses, thus avoiding the need to limit the bandwidth or compromise noise reduction performance to maintain stability.

One preferred embodiment of the invention addresses in particular variations in the leakage of noise past the ESD and into the listener's ear and, in this respect, it is preferred to limit the adaptive filter to low orders; typically less than 10^{th} order. In some embodiments, the limitation can be to 2^{nd} or 3^{rd} order.

It is thus a feature of such embodiments of the present invention to constrain the feed-forward filter to fall within such a range of filter responses, thereby to provide a system operating over a wide bandwidth without stability concerns.

In further embodiments of the invention, it is preferred that, since the variation in filter shape is progressive and of a simple nature, the required filter characteristic is characterised by analysing the microphone signals in relatively few frequency bands. In one embodiment, a single frequency band is analysed.

In more complex situations, two or more frequency bands are analysed.

In preferred embodiments, the analysis in one or more frequency bands is implemented using bandpass filters. In other preferred embodiments, transforms such as the fast Fourier transform (FFT) are employed.

Further preferred embodiments of the invention include means to inhibit the adaptive controller against attempting to adapt the filter when the ambient noise signal falls to a low level, or where the ambient noise is at such a low level that electronic system noise or inherent microphone noise masks the ambient noise signal, as such operation is likely to be erroneous.

In one such embodiment, this condition is detected by measuring the amplitude of the first electrical signal and comparing it with a threshold value. In other embodiments, the system provides an indication of the reliability of the measurement, and hence whether or not the filter should be adapted.

In preferred embodiments addressing a situation in which a desired audio signal, i.e. one such as music or speech, which a listener wishes to hear, is applied to the speaker of the ESD, means are provided for subtracting a filtered version of the desired audio signal from the error microphone signal the error microphone signal, in order to minimise the interference with the operation of the adaptive controller.

Further preferably, in such situations, the filter operating on the desired signal is configured to have the same amplitude and phase response as the path that the desired audio signal undergoes in passing, via the ESD's speaker, to the error microphone. Moreover, since this path is dependent on the acoustic leakage, the filter is preferably adaptive and adjusts to the prevailing acoustic conditions.

However, even where such compensation is implemented, it is not perfect in practice and, if the ambient noise signal is small enough, the error microphone signal will be due predominately to the desired audio signal, and the adaptive controller will not be able to operate. To address this limitation, there is preferably provided, according to a further aspect of the present invention, a second procedure for determining the amount of acoustic leakage which is operated when a desired audio signal of sufficient strength is present.

Thus, in accordance with alternative embodiments of the invention, alternative systems are provided for ascertaining the optimal electronic filters. One of these systems works best with a desired audio signal and no ambient noise, and the other works best with ambient noise and no desired audio signal. It is a further aspect of the invention that the system is selectable, or switchable, in response to the relative levels of the ambient noise and desired audio signals.

Certain embodiments of the invention are configured to directly address another problem described earlier; that concerning a situation in which the user speaks. A preferred such embodiment employs an electrical signal indicative of the voiced sounds, such as that available in a communications headset or telephone handset incorporating a voice microphone arrangement. Such an electrical signal is, in some such embodiments, used in association with a threshold detector, configured to detect whether the user is speaking or not, and means for disabling the operation of said control means when the user speaks, so as to prevent false operation of the adaptive controller.

In alternative such embodiments, the electrical voice signal is filtered and subtracted from the error microphone signal to cancel out the unwanted voice signal transmitted through the user's head. Preferably, the voice filter is adapted, to optimise its response to match the prevailing acoustic conditions.

In further embodiments, providing an alternative means of addressing situations in which a user speaks, advantage is taken of the observation that a voice signal picked up by the error microphone undergoes a low-pass filter characteristic in passing through the bones and other materials of the human head. In these preferred embodiments, the filters of the adaptive controller are configured to use one or more frequency bands which are above the low-pass filter characteristics of the human head, thereby to minimise disturbance from the user's voice signal.

In still further embodiments, providing further alternative means of addressing situations in which a user speaks, the time response of the adaptive controller is configured to be sufficiently long that it does not respond fast enough to react to the user's spoken words.

In order that the invention may be clearly understood and readily carried into effect, embodiments thereof will now be described, by way of example only, with reference to the accompanying drawings of which:

FIGS. 1 and 2 show, in block-diagrammatic form, the elements of certain prior art feed-forward noise reduction systems and have already been referred to;

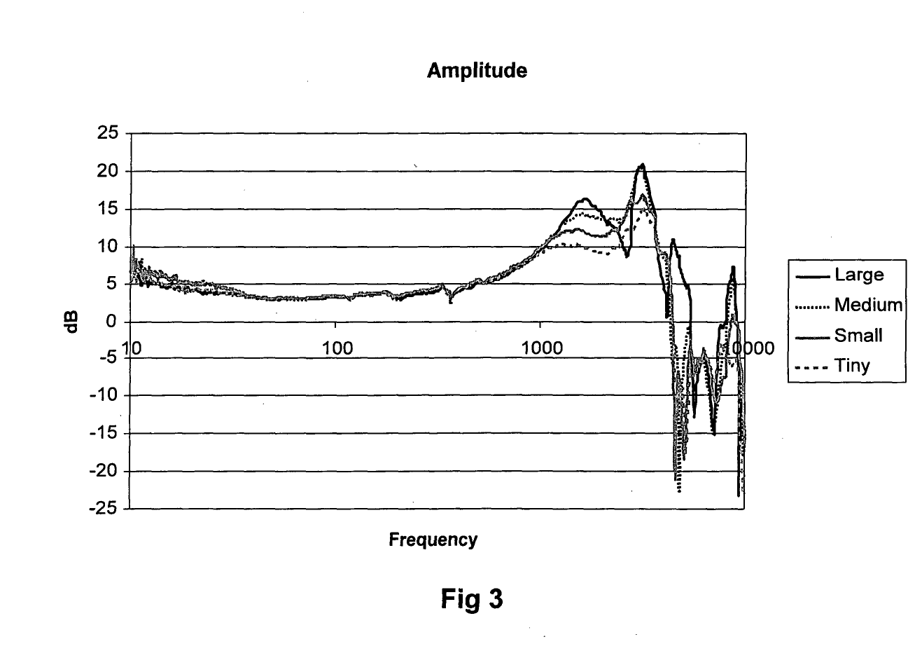

FIG. 3 is a graph illustrating a noise transfer function amplitude response for acoustic leaks of several sizes;

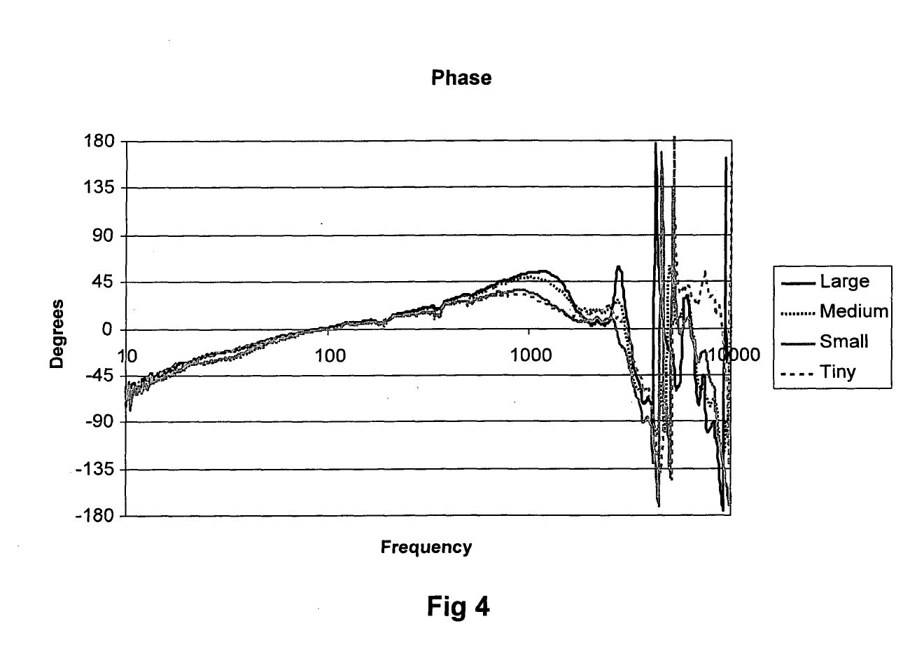

FIG. 4 is a graph illustrating a noise transfer function phase response for acoustic leaks of several sizes;

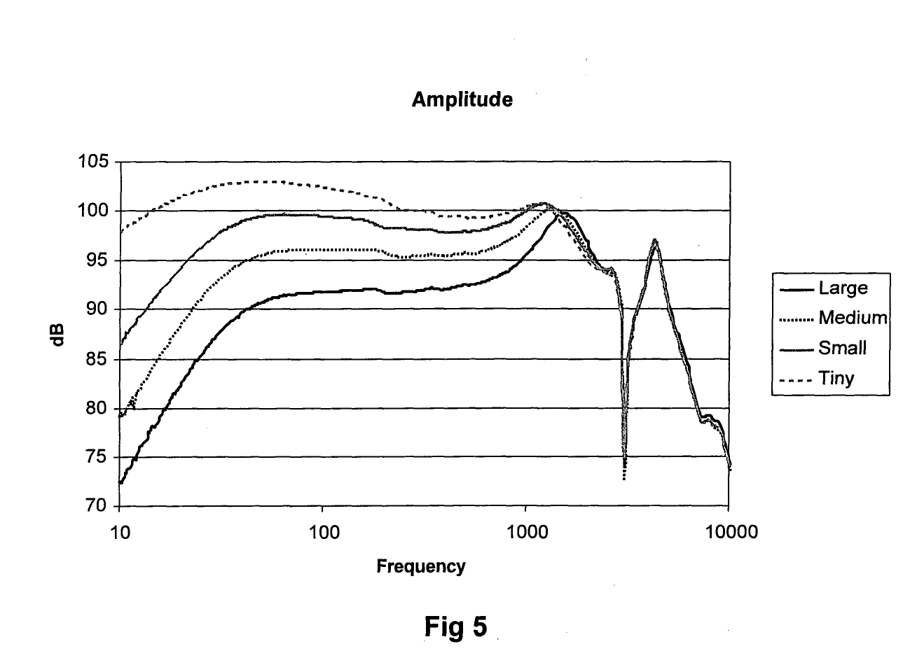

FIG. 5 is a graph illustrating speaker amplitude response for acoustic leaks of several sizes;

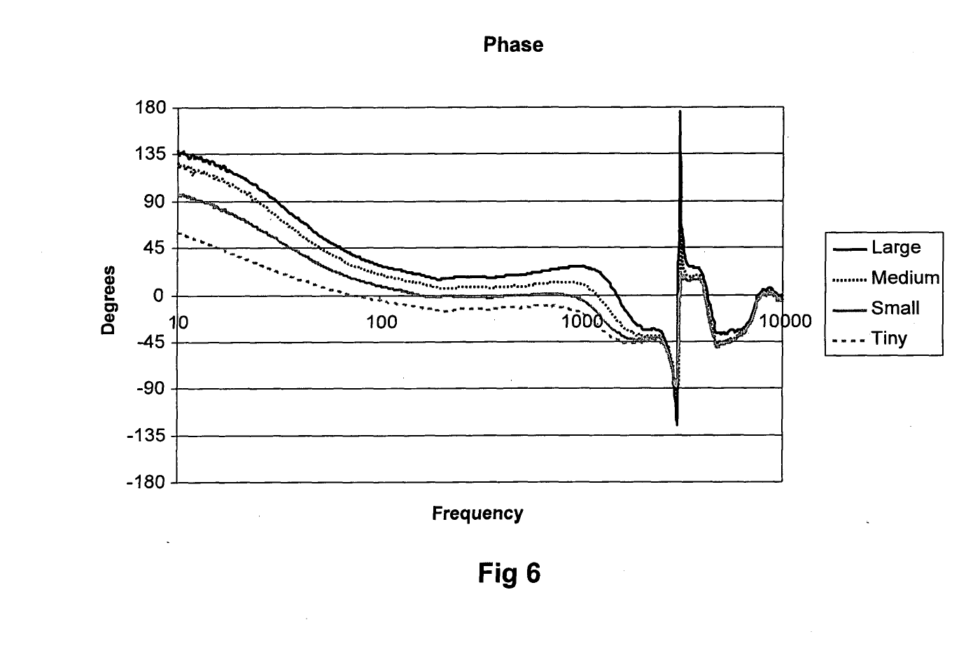

FIG. 6 is a graph illustrating speaker phase response for acoustic leaks of several sizes;

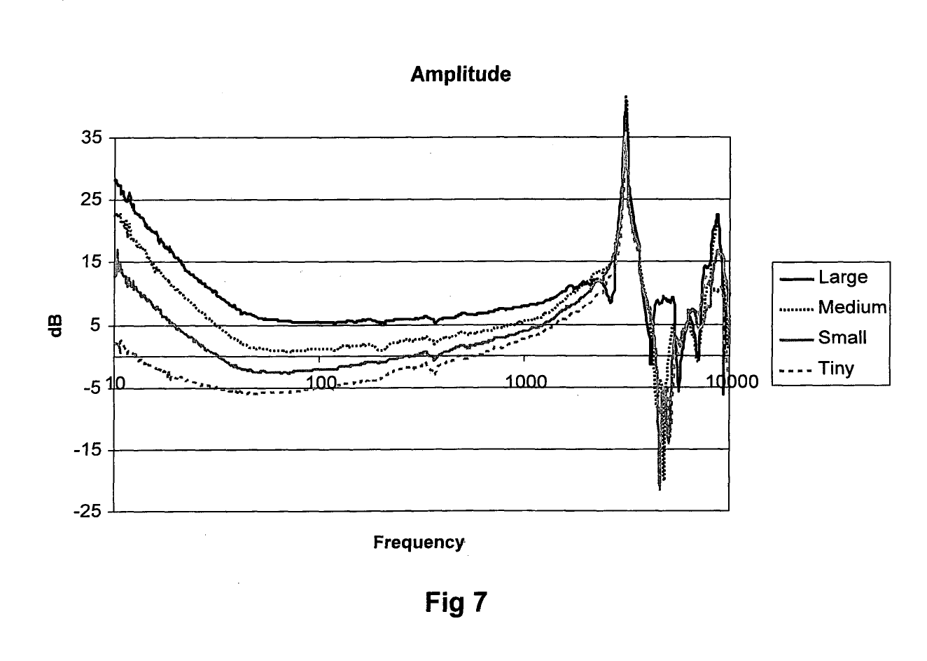

FIG. 7 is a graph illustrating desired electronic filter amplitude response for acoustic leaks of several sizes;

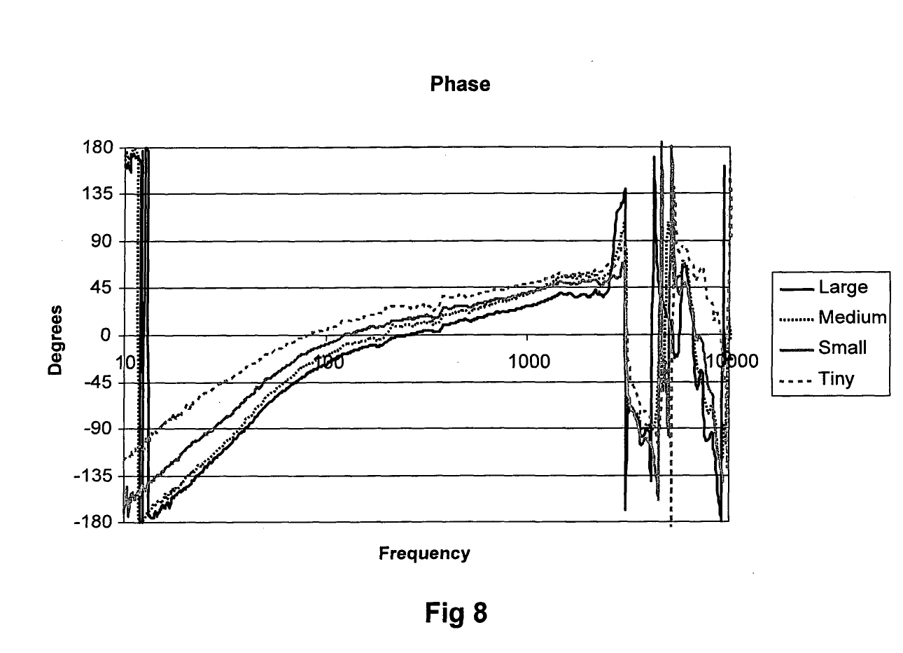

FIG. 8 is a graph illustrating desired electronic filter phase response for acoustic leaks of several sizes;

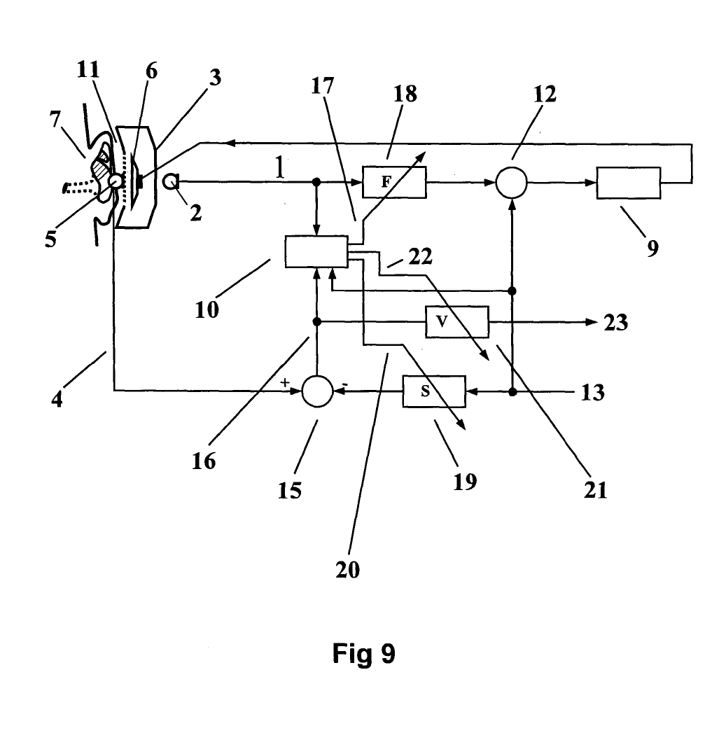

FIG. 9 shows, in block-diagrammatic form, an embodiment of an adaptive feed-forward noise reduction system according to one example of the invention;

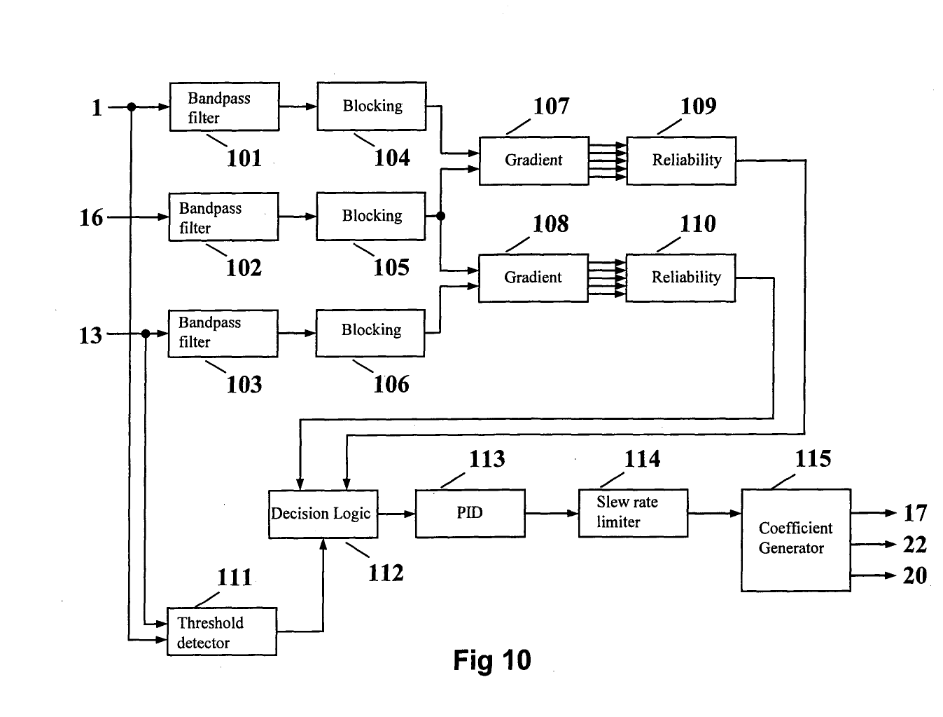

FIG. 10 shows, in block-diagrammatic form, an example of an adaptive controller suitable for use in a system of the kind shown in FIG. 9;

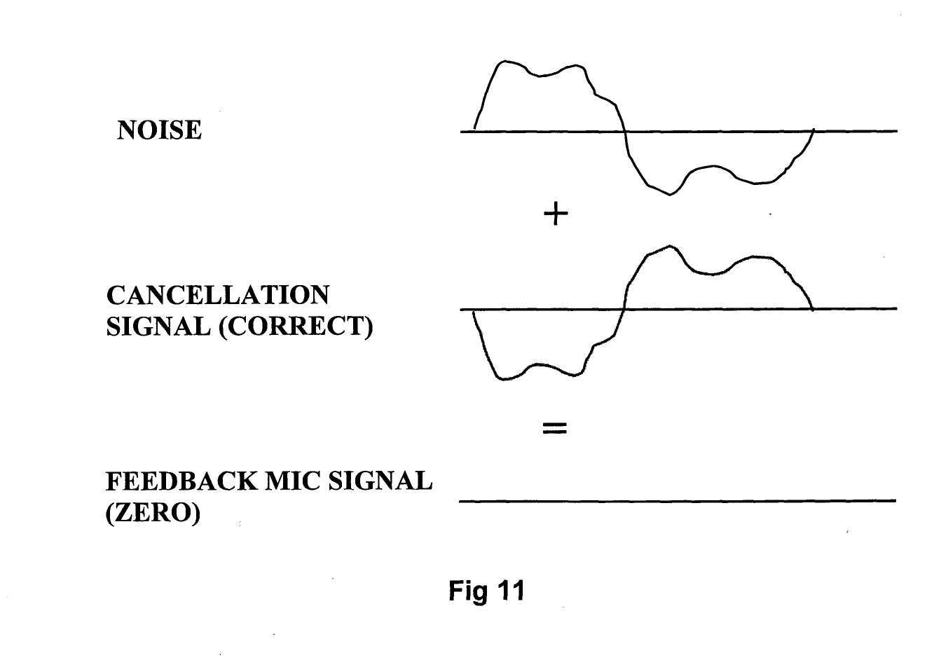

FIGS. 11, 12 and 13 illustrate graphically, and in schematic form, noise cancellation achieved with filters of correct, insufficient and excessive gain respectively;

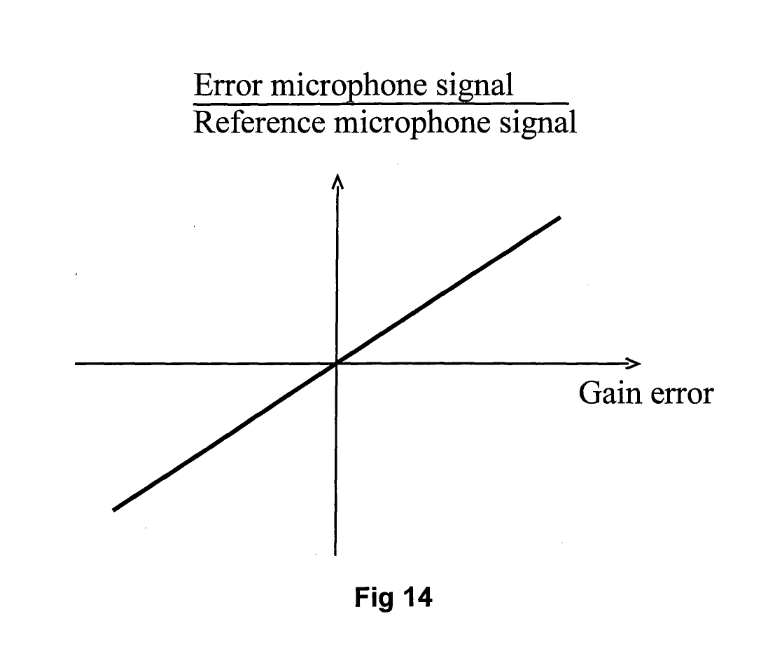

FIG. 14 shows, as an idealised graph, the relationship of microphone amplitude ratio to gain error; and

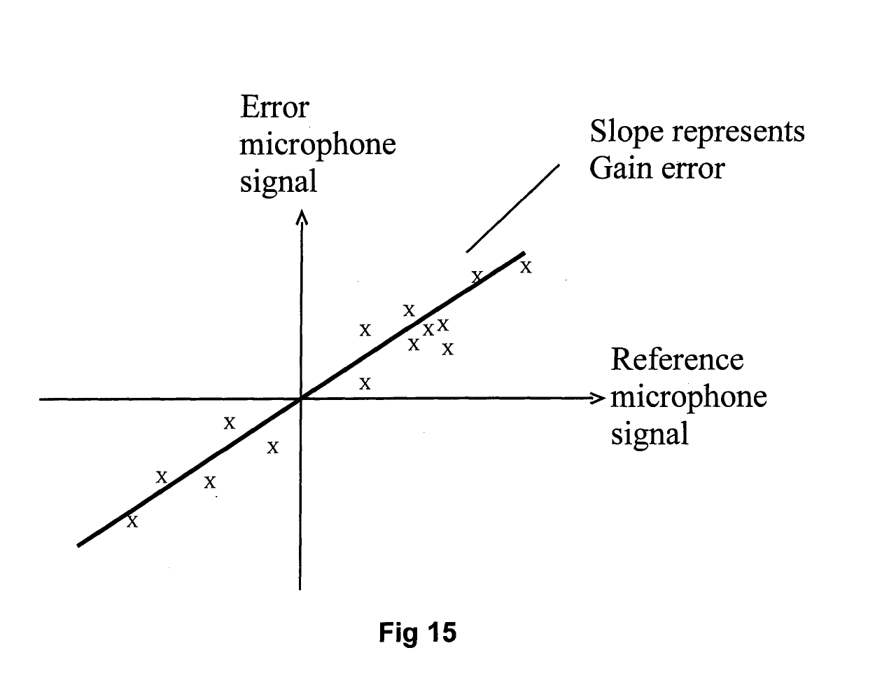

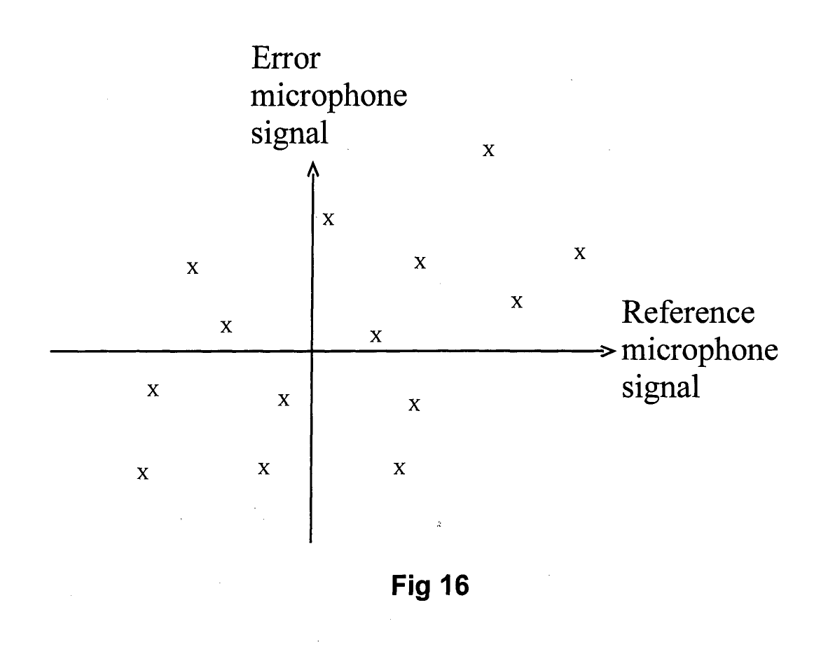

FIGS. 15 and 16 show, in graphic form and as plots, representations of microphone signals with good and poor signal-to-noise ratios respectively.

In order to assist in explaining the functionality of the invention in its various aspects and embodiments, some general background information will now be provided, before detailed embodiments are described.

As a result of studying the practical requirements for adaptive feed-forward noise reduction, the inventors have determined that it is not desirable to allow the adaptive feed-forward filter to take an almost infinite variety of shapes, as many of these filter shapes are never required and some are even indicative of erroneous behaviour of the control system. It is this excessive flexibility which leads, at least in part, to the stability problems described above. Thus, for example, the LMS algorithm is not the optimal choice of algorithm for noise reduction applications, because it allows the filter to be adapted with too much freedom; it is capable of adapting the feed-forward filter to any transfer function that can be achieved by a FIR filter of that order. Many such transfer functions will never be required in practice and some at least are highly undesirable transfer functions as they are indicative of erroneous operation of the adaptive filter.

The inventors have studied the feed-forward filter responses which are required in practice for various applications, and have ascertained that a major factor affecting the required filter response is the variation of acoustic leakage, described above, which alters two key properties of the noise reduction system.

Firstly, the amount of ambient noise relative to the reference (N) which enters the ear increases if the amount of acoustic leakage increases. FIG. 3 (amplitude) and FIG. 4 (phase) show a set of transfer functions for N for varying amounts of leakage, measured on a supra-aural headphone. It can be seen that leakage has little effect up to about 1 kHz, but there is a significant effect at around 2 kHz, with a larger resonant peak and more positive phase occurring for larger leakages.

Secondly, if the amount of acoustic leakage increases, the sound pressure level produced by the speaker decreases, especially at low frequencies. FIGS. 5 (amplitude) and 6 (phase) show the measured variation in S. It can be seen that there is a resonant effect around 2 kHz, relatively little effect above this frequency, but a pronounced effect below 1 kHz. As the amount of leakage is increased, the speaker output at low frequencies falls and the positive phase shift increases.

It is straightforward to derive the set of ideal electronic filters from this measurement data, for example as described in U.S. Pat. No. 5,138,664 to Kimura et al. FIGS. 7 (amplitude) and 8 (phase) show the required filter responses derived in such a way from the measurements of FIGS. 3 to 6. Since the amplitude plots of FIGS. 3 and 5 are in dB, the method amounts to a subtraction of the values of FIG. 5 from the corresponding values of FIG. 3 (to form FIG. 7) and from the corresponding values of FIG. 6 from FIG. 4 (to form FIG. 8). It is notable that the resonant effects around 2 kHz largely cancel out, since the changing resonant properties almost equally affect both the speaker response and the noise ingress, thus requiring little change to the filter. However, below 1 kHz there is a clear and smooth trend with changing leakage, with the need for more gain in the filter for higher leakages and for lower frequencies. Similar data are obtained for other applications, such as an ear-bud or a telephone handset.

The curves of FIGS. 7 and 8 are ideal electronic filter characteristics, but it is not obvious how to produce practical realisable filters from this data. However, our co-pending UK patent application No. 0701483.0 describes a method of determining the required electronic filter response (both amplitude and phase) from such measurement data. It is thus possible to produce a family of realisable filters from such data. The inventors have found that these filters are of relatively low order, as would be expected from the smoothness of the curves of FIGS. 7 and 8, typically being less than 10^{th} order, and often only 2^{nd} or 3^{rd} order. It is a feature of certain embodiments of the present invention therefore to constrain the feed-forward filter to fall within such a range of filter responses, unlike the prior art systems, which impose no constraint whatsoever on the filter shape.

Thus, in such embodiments of the invention, the filter response can be selected from amongst a family of filter responses, having a mutually related set of frequency-dependent characteristics, in which each successive member of said set corresponds to a methodical, incremental change in one parameter of the system (such as the acoustic leakage in the example given above), within a pre-determined range of values, the range of values being chosen to encompass the anticipated variation of the parameter in practical usage.

In the illustrated example, where the acoustic leakage varies within a pre-determined range, this gives rise to a family of filter responses as shown in FIGS. 7 and 8, and the system in accordance with the invention allows the selection of a filter response that is constrained to come from within that family of filter responses.

It will be appreciated that other families of filter responses can be devised, each member of a family corresponding to a different value of some parameter of the system, such that the members of a family of filter responses have related amplitude and phase characteristics.

It is thus possible to provide a system operating over a wide bandwidth without stability concerns.

It was shown earlier that

F·S=N

and it has been shown that, below around 1 kHz, N is constant. Furthermore, it has been shown that higher frequency effects in N and S cancel out so that it is unnecessary to incorporate them into the adaptive system. It is therefore clear that any change to F should be accompanied by an opposite change in S, such that the product of F and S remains unchanged.

The electronic filter comprised in systems according to embodiments of the present invention can be implemented in analogue, digital or hybrid forms. Digital filters can be of the finite impulse response (FIR) or infinite impulse response (IIR) type. Since the filter response shaping is primarily required at low frequencies, as explained above, the poles and zeroes of the filter are all positioned at the low frequency end of the spectrum. The IIR filter is therefore much better suited than the FIR filter, as an FIR filter would need to be of high order to provide the low frequency poles and zeroes, whereas the IIR filter can provide this easily within a low order filter. An efficient filter can therefore be implemented digitally.

Thus, a constrained feed-forward filter is not only sufficient, but actually desirable for noise reduction.

The issue now arises as to how to automatically adjust the filter shape (within its constrained terms of operation). In this regard, the inventors have determined that, since the variation in filter shape is progressive and of a simple nature, it is possible to characterise the required filter characteristic by analysing the microphone signals in relatively few frequency bands. In the simplest case, where it is ascertained that the primary variation in the family of filters is a simple gain change (or that a gain change alone provides sufficient noise reduction performance), a single frequency band can be used, the breadth of which can be selected to optimise practical system behaviour, and can range from a narrow band to a broad band, or even the entire audio spectrum.

The next level of complexity involves analysis in two frequency bands. As more analysis frequencies are added, it is clear that more variation in the filter shape can be accommodated. Those skilled in the art will realise that the analysis in frequency bands can be implemented using bandpass filters, transforms such as the fast Fourier transform (FFT), or other methods.

When the ambient noise signal falls to a low level, or where the ambient noise is at such a low level that electronic system noise or inherent microphone noise masks the ambient noise signal, the adaptive controller has no signal on which to operate. It is another object of the invention to inhibit the adaptive controller against attempting to adapt the filter under such conditions, as such operation is likely to be erroneous. In a first embodiment, this condition is detected by measuring the amplitude of the reference microphone signal and comparing it with a threshold value. In a more comprehensive embodiment, the system provides an indication of the reliability of the measurement, and hence whether or not the filter should be adapted. Such a system is described hereinafter by way of example.

In the situation where a desired audio signal is present, the error microphone signal will contain a large contribution from the desired audio signal. As has been described earlier, a filtered version of the desired audio signal can optionally be subtracted from the error microphone signal in order to minimise the interference with the operation of the adaptive controller; the filter being designed to have the same amplitude and phase response as the path that the desired audio signal undergoes in passing from the input, through the amplifier and speaker to the error microphone. Since this path is dependent on the acoustic leakage, the filter is ideally adaptive and adjusts to the prevailing acoustics conditions. However, even if such compensation is implemented, it will not be perfect in practice and, if the ambient noise signal is small enough, the error microphone signal will be due predominately to the desired audio signal, and the adaptive controller will not be able to operate. To address this limitation, there is provided, according to a further aspect of the present invention, a second procedure for determining the amount of acoustic leakage which is operated when a desired audio signal of sufficient strength is present. This procedure will now be described.

The effect of acoustic leakage variations on the transfer function from the speaker to the error microphone (S) is shown in FIGS. 5 and 6. In particular, the low frequency roll-off is influenced in a predictable way by the leakage.

According to this embodiment of the invention, there are two ways in which S can be determined:

(a) In the event that a compensation filter for the desired audio signal is not implemented, it is possible to determine S by using the desired audio signal itself as a test signal, and analysing the error microphone signal relative to the speaker drive signal.

(b) In the event that a compensation filter for the desired audio signal is implemented, the adaptive controller can operate using the error signal as before and the desired audio signal in place of the reference microphone signal. The same adaptive controller algorithm is then capable of generating filter coefficients for the compensation filter. Once S is known, F can readily determined, as the product of F and S is constant, as has been described above. If ambient noise is present, it will interfere with this measurement process, so this method works best in the absence of ambient noise.

Thus, in accordance with alternative embodiments of the invention, alternative systems are provided for ascertaining the optimal electronic filters. One of these systems works best with a desired audio signal and no ambient noise, and the other works best with ambient noise and no desired audio signal. It is a further aspect of the invention that the system is selectable in response to the relative levels of the ambient noise and desired audio signals.

Certain embodiments of the invention are configured to directly address the problem described earlier concerning the situation when the user speaks. A preferred embodiment makes use of an electrical version of the voice signal, such as that available in a communications headset or telephone handset incorporating a voice microphone arrangement, which may optionally be of the noise cancelling type. This electrical signal can be used in two ways. Firstly, it can be used with a threshold detector, to detect whether the user is speaking or not, and the adaptive controller can be disabled in this eventuality to prevent false adaptive operation. Secondly, a filtered version of the electrical voice signal can be subtracted from the error microphone signal to cancel out the unwanted voice signal transmitted through the user's head. It is also possible to adapt such a voice filter, using the methods described in the present invention, to optimise its response to match the prevailing acoustic conditions. The technique of using threshold detectors can be extended to include a voice threshold detector, allowing three distinct extreme cases to be distinguished, where there is present only (a) a desired audio signal, (b) ambient noise, or (c) the user's voice.

The inventors have realised that there is a second solution to this voice problem, which does not require the use of a voice microphone. The voice signal picked up by the error microphone undergoes a low-pass filter characteristic in passing through the bones and other materials of the human head. Thus, by designing the filters of the adaptive controller to use one or more frequency bands which are above the low-pass filter characteristics of the human head, the disturbance from the voice signal will be minimised. It is an object of another embodiment of the present invention that the adaptive controller implements such a filter arrangement.

A third solution is to make the adaptive controller response time long so that it does not respond fast enough to react to the user's spoken words.

It will be appreciated that, under ideal circumstances, the error signal 16 will be a noise-free representation of the user's voice. It is therefore a further object of the invention to use this signal as the source for the transmit path of a two-way communications device such as a headset or telephone.

As described earlier, the voice signal transmitted through the head and picked up by the error microphone is low-pass filtered. To restore the fidelity of the voice, an equalisation filter is optionally used. The transfer function through the head from the voice source to the error microphone is however affected by the amount of acoustic leakage, so this equalisation filter is ideally also of the adaptive type.

The invention will now be described in more detail, by way of example only. Throughout the following description, a single reference microphone and single error microphone are referred to, but the invention is equally applicable to any configuration of multiple microphones in each case.

FIG. 9 shows a block diagram of one embodiment of the invention, in which elements common to those in FIG. 2 are labelled with the same numbers. Relative to FIG. 2, the adaptive filter 8 has been replaced by a constrained adaptive filter 18; the compensation filter 14 has been replaced by a constrained adaptive compensation filter 19; the desired audio signal 13 is fed into an additional input of the adaptive controller 10; and an additional output 20 of the adaptive controller 10 provides the filter coefficients S for the constrained adaptive compensation filter 19. The adaptive controller 10 is shown in FIG. 10, and will be described later.

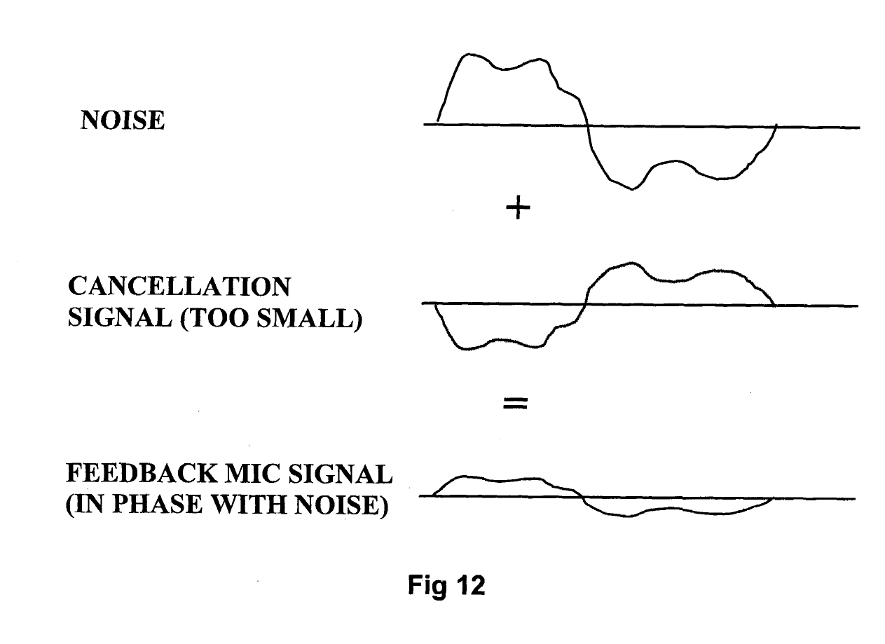

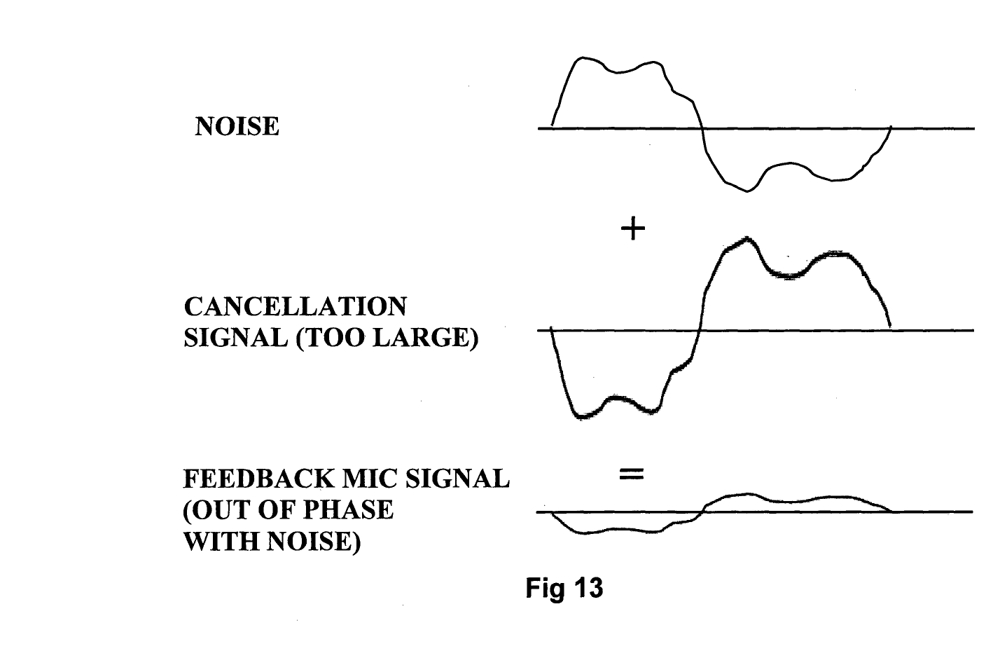

The operation of the adaptive controller 10 will first be described for the simplified case when only the gain of constrained adaptive filter 18 needs to be varied, and there is no desired audio signal present. Under these conditions, if the gain of constrained adaptive filter 18 is exactly correct, the noise reduction will be perfect and the error microphone 5 will pick up no signal, as shown in FIG. 11.

Where the gain of the constrained adaptive filter 18 is too low, as shown in FIG. 12, the reduction signal will be too small and some residual ambient noise will be picked up by the error microphone 5. The error microphone signal 4 will be in phase with the reference microphone signal 1, and the ratio of the amplitudes of the two microphone signals will depend on the filter gain error, i.e. the fractional error equal to the amplitude of the error microphone signal 5 divided by the amplitude of the reference microphone signal 1 is large if the gain error is large, and small if the gain error is small.

Where the filter gain is too high, as shown in FIG. 13, the reduction signal will be too large and some residual ambient noise will be picked up by error microphone 5. This time, however, the error microphone signal 4 will be in phase with the acoustic signal generated by the speaker 6 and hence in anti-phase with the reference microphone signal 1, and the fractional error, as defined above, will be negative and proportional to the filter gain error.

FIG. 14 shows the relationship between filter gain error and the fractional error, and it can be seen that it is a straight line. However, if the amplitude ratio is determined as described above, the gain error cannot be calculated directly because the slope of the line is not known precisely. Nevertheless, for practical implementations, the slope is known approximately (within the tolerances of the component values), so the filter gain error can be estimated. The estimated value can then be applied and a further error measurement made. By a process of successive approximation, the null point will rapidly be found. Even if the slope were not known approximately, the null point could soon be found by merely using the sign of the fractional error (i.e. whether the signals are in phase or out of phase) to determine whether to slowly increase or decrease the filter gain. As in any control system, the response time of the control loop must be designed in order to prevent instability.

This control algorithm operates independently of the absolute level of the ambient noise and therefore suffers from the problem described earlier under conditions where the ambient noise level falls to a level which is below the electronic or microphone noise level of the system. One solution to this problem is to disable the control algorithm when the signals fall below some threshold, but this is not the preferred solution, since it poses a problem in setting the threshold correctly. A preferred solution is to estimate the filter gain error from a number of microphone signal measurements made during a certain time interval. FIG. 15 shows a plot of the error microphone signal 5 against the reference microphone signal 1 for the situation where there is a strong ambient noise signal (and hence a good signal to noise ratio (SNR), where the “signal” is the ambient noise, and the “noise” is electronic noise or the desired audio signal). It can be seen that the measurement points are scattered around a straight line, the slope of which can be estimated with reasonable accuracy from the measurement data. The slope is clearly a good indicator of the filter gain error. In the case where the ambient noise level is low, and hence the SNR is poor, the measurement data are more scattered, as shown in FIG. 16, and it is not possible to estimate a slope with a sufficient degree of reliability. Well known standard mathematical methods are available for determining the reliability of slope estimation, thus it is possible to directly determine the reliability of the filter gain error estimate from the measured data, allowing the adaptive controller to be disabled when the data quality is poor.

Referring now to FIG. 10, wherein the input and output signals correspond to those with the same numbers in FIG. 9, reference input 1 and error input 16 are fed into identical bandpass filters 101 and 102 respectively, which define a measurement frequency band. The outputs of these filters are fed into blocking units 104 and 105 respectively which form blocks of samples, typically of 1024 samples, for analysis. Gradient estimator 107 takes the outputs of the blocking units 104 and 105 and performs the mathematical operations required to estimate the slope as shown in FIGS. 15 and 16. This estimate does not need to be highly accurate, so it is possible to make computational shortcuts, for example by basing the gradient estimation on averages rather than the more conventional square root of squares approach.

Gradient estimator 107 produces a number of outputs relating to a time series of data blocks. Reliability detector 109 processes this series of gradient estimates to determine whether all the gradient estimates fall within a range which is less than some predefined limit, thus indicating whether the gradient estimate is consistent from block to block. Threshold detector 111 compares the amplitude of the reference input 1 and desired input 16 with threshold values and feeds an output to decision logic 112, which is also fed from reliability detector 109. Decision logic 112 decides whether the gradient estimate is reliable, and if so, passes it on to Proportional Integral Derivative (PID) controller 113. PID controller 113 is a standard control loop device, well known to those skilled in the art. The output of PID controller 113 is a new value of filter gain for the frequency band determined by bandpass filters 101 and 102. An optional slew rate limiter 114 limits the rate at which the filter is allowed to change, providing a better user experience. The output of slew rate limiter 114 is fed to the coefficient generator 115, which generates the filter F coefficients 17 which are fed to the constrained adaptive filter 18 of FIG. 9. Coefficient generator 115 also calculates the filter S coefficients 20 from the filter F coefficients 17, and feeds them to constrained adaptive compensation filter 19 of FIG. 9. It was shown earlier than filters F and S are related by the product being constant, so it is straightforward to generate one once the other is known.

In the simple case where only the gain of the filter is changed, the coefficient generator 115 reverts to a simple gain scaling operation, which optionally can be implemented separately from the filter, so that the filter coefficients are not modified. In the more general case where the filter shape and gain are modified, the coefficient generator 115 may include look-up tables of filters or parametric algorithms to calculate the required filter within a constrained set according to a set of rules.

In order to address the situation in which a desired audio signal is present, but there is no ambient noise, and with further reference to FIG. 10, desired input 13 and error input 16 are fed into identical bandpass filters 103 and 102 respectively, which define a measurement frequency band, for example 300 to 600 Hz. The outputs of these filters are fed into blocking units 106 and 105 respectively. Gradient estimator 108 takes the outputs of the blocking units 106 and 105 and performs the mathematical operations required to estimate the slope as shown in FIGS. 15 and 16. Gradient estimator 108 and reliability detector 110 operate in an analogous way to that described previously and the remainder of the circuit works as described previously, except that coefficient generator 115 generates the filter S coefficients 20 directly, and calculates the filter F coefficients 17 from them.

The threshold detector 111 operates in such a way that an optimal adaptive control procedure is selected, depending on the relative signal levels of the reference input (ambient noise) and desired audio signal.

The above description applies to the situation when only the gain of the filter is required to be adapted. The bandpass filters 101, 102 and 103 select a single frequency band for analysis. In practice, there is some variability in the required filter spectrum as the acoustic leakage changes, as described earlier, and it is possible to use a look-up table or other method to vary the filter response based on analysis in this single frequency band. For example, it can be seen from FIG. 5 that the gain at 100 Hz varies by approximately 10 dB across the range of acoustic leakages shown, whereas at 1 kHz the variation is about half this figure.

To allow for a range of earphone types within one adaptive controller, or in order to have more information about the effect of the acoustic leakage, it is in some circumstances desirable to perform the analysis in more than one frequency band. This is readily achieved by restricting the bandpass filters to a narrower range such that two or more distinct bands can be defined. Either additional sets of bandpass filters are implemented for the additional frequency bands (parallel operation), or the one set is made switchable (serial operation). In either case, the adaptive controller is able to estimate filter gain corrections in each frequency band. The coefficient generator 115 then selects or computes an optimal filter to match the gain estimates in each measured frequency band.

In general, the ideal filter in any given situation will not be contained within the constrained set of available filters, and some compromise has to be made. In order to optimise noise reduction performance, it is desirable to optimise performance according to some frequency dependent metric, such that the filter used from within the constrained set is selected in order to optimise this metric. For example, one can choose to optimise the filter in the frequency band where the ambient noise has the most power, or alternatively to optimise the filter in the frequency band where the ratio of the desired audio to ambient noise is least. This frequency-dependent behaviour can use the same bandpass filters which have been described earlier, or can alternatively use secondary frequency-selective analysis means.

By selecting the analysis frequency bands to avoid the low voice frequencies transmitted through the user's head whilst speaking, it is possible to avoid the aforementioned problem of false adaptive controller operation when the user speaks.

FIGS. 9 and 10 show a further aspect of the invention, whereby a voice output signal representative of the user's voice is produced by the invention. Error signal 16 consists of the user's voice transmitted through the head only, as the ambient noise (including the user's voice transmitted through the air) and the desired audio signal are both cancelled by the invention, as described previously. The voice signal component in error signal 16 is however filtered by its passage through the head and is affected by the cavity formed between the speaker 6 and ear 7, and preferably frequency response correction is required. This is the function of constrained adaptive equalisation filter 21, which receives error signal 16 and outputs the voice output signal 23. Adaptive controller 10 outputs the filter V coefficients 22 to control filter 21. These filter coefficients may be fixed in some applications, but since the ideal voice equalisation filter is affected by S, the ability to adapt the filter is provided. The filter is constrained in the same way as the other filters, as it is only required to adapt to gradual changes in the acoustic leakage. The optimal control algorithm is determined experimentally.

In the present invention, it is not necessary to provide close proximity of the error microphone to the speaker, as the microphone does not form part of the primary audio processing circuit. The error microphone can therefore be positioned inside the cavity, but may optionally also be placed outside the cavity and connected via an acoustic tube to the inside of the cavity. The time delay caused by the tube does not affect the performance of the system, and any frequency response modification of the error microphone signal caused by the tube can be allowed for in the adaptive controller design. Such flexibility in the physical arrangement is a great benefit for some earphone types, for example the ear-bud, where it would be difficult to mount the error microphone inside the cavity, but it would be perfectly feasible to provide a narrow acoustic tube connecting the cavity to an externally mounted error microphone.

1. An adaptive feed-forward system for reducing ambient noise perceived by a listener to an ear-proximal speaker-carrying device, the system comprising
a reference microphone means for sensing ambient noise approaching the device and for providing first electrical signals representative of the noise sensed thereby;
a connection path conveying said first electrical signals to a speaker of the device;
inverting means in said connection path for inverting said first electrical signals;
an adaptive electronic filter means in said connection path; and
a control means for adjusting one or more characteristics of said filter means in response to said first electrical signal, wherein said adaptive filter means is constrained to always conform to one of a predetermined family of filter responses, and thereby to operate within a predetermined and limited set of amplitude and phase characteristics.

2. A system according to claim 1, wherein the adaptive filter is limited to orders less than 10.

3. A system according to claim 1, wherein the adaptive filter is limited to orders less than 3.

4. A system according to claim 1, wherein the microphone signals in a single frequency band are analysed.

5. A system according to claim 4, wherein the analysis is implemented using band-pass filters.

6. A system according to claim 4, wherein the analysis is effected by means for implementing transforms, such as fast Fourier transforms.

7. A system according to claim 1, further including means to inhibit the adaptive controller against attempting to adapt the filter when the ambient noise signal falls below a prescribed level.

8. A system according to claim 7, further including means for measuring the amplitude of the first electrical signal and comparing it with a threshold value.

9. A system according to claim 1, further including means for inhibiting interference with the operation of the adaptive controller from a desired audio signal, such as music or speech, which a listener wishes to hear.

10. A system according to claim 9, wherein the means for inhibiting interference includes means for subtracting a filtered version of the desired audio signal from the error microphone signal.

11. A system according to claim 10, wherein the filter operating on the desired signal is configured to have the same amplitude and phase response as the path followed by the desired audio signal in passing, via the ESD's device's speaker, to the error microphone.

12. A system according to claim 11, wherein, said filter operating on the desired signal is adaptive and configured to adjust to the prevailing acoustic conditions.

13. A system according to claim 1, further comprising means for determining the amount of acoustic leakage and switchable means for actuating said determining means only when a desired audio signal of at least a predetermined amplitude level is present.

14. A system according to claim 1, further comprising compensating means, effective when a user of the device speaks, to mitigate the effects upon the system of voiced sounds associated with the user's speech.

15. A system according to claim 14, wherein said compensating means is provided with an electrical signal indicative of the voiced sounds, and includes means for utilising said electrical signal to effect said compensation.

16. A system according to claim 15, wherein said means for utilising comprises a threshold detector, configured to detect whether the user is speaking or not, and means for disabling the operation of said control means when the user speaks, thereby to inhibit false operation of the adaptive controller.

17. A system according to claim 16, further comprising means for filtering the electrical voice signal and for subtracting the filtered voice signal from the error microphone signal to cancel out the unwanted voice signal transmitted through the user's head.

18. A system according to claim 17, wherein the voice filter is adapted to optimise its response to match the prevailing acoustic conditions.

19. A system according to claim 14, wherein the filters of the adaptive controller are configured to use one or more frequency bands which are above low-pass filter characteristics associated with the human head, thereby to reduce disturbance from the user's voice signal.

20. A system according to claim 14, wherein the time response of the adaptive controller is configured to be sufficiently long that it does not respond fast enough to react to the user's spoken words.

21. A system according to claim 1, wherein said adaptive filter means further comprises an adjustable time delay element in series therewith.

22. (canceled)

23. The system according to claim 1, further comprising an error microphone means for sensing sounds approaching the ear canal of the listener and for providing second electrical signals representative of the sounds sensed thereby, said sounds including noise generated by the speaker of the device in response to the inverted first electrical signals conveyed thereto over said connection path, wherein said control means adjust one or more characteristics of said filter means in response to said first and second electrical signals.

24. An adaptive feed-forward system for reducing ambient noise perceived by a listener to an ear-proximal speaker-carrying device, the system comprising:
a reference microphone means for sensing ambient noise approaching the device and for providing first electrical signals representative of the noise sensed thereby;
a connection path conveying said first electrical signals to a speaker of the device, means in said connection path for inverting said first electrical signals;
an adaptive electronic filter means in said connection path, said adaptive filter means having a plurality of possible filter responses, each of said possible filter responses corresponding to a respective amount of acoustic leakage past the device within a predetermined range;
an error microphone means for sensing sounds approaching the ear canal of the listener and for providing second electrical signals representative of the sounds sensed thereby, said sounds including noise generated by the speaker of the device in response to the inverted and filtered first electrical signals conveyed thereto over said connection path; and
a control means for selecting one of said possible filter responses in response to said first and second electrical signals.

25. A system according to claim 24, further including means to inhibit the adaptive controller against attempting to adapt the filter when the ambient noise signal falls below a prescribed level.

26. A system according to claim 24, further including means for inhibiting interference with the operation of the adaptive controller from a desired audio signal, such as music or speech, which a listener wishes to hear.

27. A system according to claim 24, further comprising compensating means, effective when a user of the device speaks, to mitigate the effects upon the system of voiced sounds associated with the user's speech.

28. An adaptive feed-forward system for reducing ambient noise perceived by a listener to an ear-proximal speaker-carrying device, the system comprising:
a reference microphone for sensing ambient noise approaching the device and for providing first electrical signals representative of the noise sensed thereby;
a connection path conveying said first electrical signals to a speaker of the device; an inverter in said connection path for inverting said first electrical signals;
an error microphone for sensing sounds approaching the ear canal of the listener and for providing second electrical signals representative of the sounds sensed thereby, said sounds including noise generated by the speaker of the device in response to the inverted first electrical signals conveyed thereto over said connection path;
an adaptive electronic filter in said connection path; and
an adaptive controller for adjusting one or more characteristics of said adaptive electronic filter in response to said first and second electrical signals, wherein said adaptive electronic filter is constrained always to conform to one of a predetermined family of filter responses, and thereby to operate within a predetermined and limited set of amplitude and phase characteristics.

29. A system according to claim 28, further including an inhibitor to inhibit the adaptive controller against attempting to adapt the filter when the ambient noise signal falls below a prescribed level.

30. A system according to claim 28, further including an inhibitor to inhibit interference with the operation of the adaptive controller from a desired audio signal, such as music or speech, which a listener wishes to hear.

31. A system according to claim 28, further comprising a compensator effective when a user of the device speaks, to mitigate the effects upon the system of voiced sounds associated with the user's speech.
